(19) United States
(12) Patent Application Publication
(10) Pub. No.: US 2006/0199736 A1
(43) Pub. Date: Sep. 7, 2006

(54) Environmentally benign bioactive formulation

(75) Inventor: Gerald J. Vasek, Westmont, IL (US)

Correspondence Address: WELSH & KATZ, LTD, 120 S RIVERSIDE PLAZA, 22ND FLOOR, CHICAGO, IL, 60606, US

(73) Assignee: VERTEC BIOSOLVENTS, INC., DOWNERS GROVE, IL (US)

(21) Appl. No.: 10/320,001

(22) Filed: Dec. 16, 2002

(51) Int. Cl. A01N 37/00; A01N 25/00; A01N 43/02

(52) U.S. Cl. 504/142; 514/450

(57) ABSTRACT

The present invention provides a composition and method of stabilizing a bioactive ingredient in a composition by including a C₁ to C₄ alkyl lactate ester in the composition. The bioactive ingredient includes pesticides, herbicides, defoliants, safeners, desiccants, plant nutrients, fungicides, insecticides and preservatives. The stabilizing includes providing a measure of defense against alkaline hydrolysis as well as solubilizing the bioactive ingredient; both of which serve to prolong the shelf-life and efficacy of the bioactive.

### BACKGROUND OF THE INVENTION

The present invention is in the field of bioactive compositions and methods relating thereto. More specifically, the field is bioactive compositions such as pesticides, herbicides, defoliants, safeners, desiccants, plant nutrients, fungicides, insecticides and preservatives.

Pesticides, herbicides or other bioactive compounds for agricultural, industrial or consumer use are typically transported, sold and stored in concentrated formulations of the bioactive ingredients together with inert ingredients. It is these formulations that are then dispersed into water or other diluents during or in preparation for the actual application or delivery of the active ingredient.

The active ingredients are usually effective in very small concentrations or quantities, so a high degree of dilution and dispersion that is often required upon actual application of the bioactive ingredient. Typically, the concentration of the inert ingredients in such a bioactive formulation is much higher than the concentration of the active ingredients.

There are several considerations that go into the selection of the inert ingredients for preparing a formulation. There are potential environmental issues regarding the inert ingredients. The inert ingredients are chemicals that are introduced into the environment, and the quantities can be relatively high. The inert ingredients or their degradation products can remain in the ground or on agricultural food products or get into the food chain. If these chemicals are not environmentally benign, environmental issues arise. Even if the inert ingredients are degradable, the introduction of large quantities of these chemicals create an environmental burden.

The inert ingredients in the formulations with the bioactive ingredients typically provide several useful functions to the formulations. The actives should be highly soluble in the formulation, the dispersion should be uniform and controllable, and, the actives should last and be effective for a good period of time. The inert ingredients contribute to solubility and stability of the actives, and to the physical qualities of the dispersion.

Typical inert ingredients of the art are generally solvents, surfactants, buffering agents and small quantities of other components. Because many active ingredients are complex organic molecules, they have limited solubility in water. In such cases, a useful inert ingredient would be a solvent that enhances the solubility of the complex organic active ingredients. When such active ingredient solubility-enhancing solvents are hydrophobic, large quantities of detergents are required to maintain good dispersibility of the organic phase throughout the dilution during application, particularly when diluted with very large quantities of water.

U.S. Pat. No. 6,342,466 B1, issued Jan. 29, 2002 to Dookhith et al. discloses biodegradable solutions of biologically active compounds that exhibit low flammability and biodegradability. The bio-active preparations have a biologically active compound dissolved in a solvent the general formula RCH(OR′)₂, ketals of the formula R₂C(OR′)₂, or orthoesters of the formula RC(OR′)₃. These biodegradable solutions are themselves highly susceptible to hydrolytic degradation.

Fisher, et al., U.S. Pat. No. 5,514,639, discuss some of the problems in the art in attempting to provide formulations for agricultural bioactives whose stability is affected by pH. Some active ingredients degrade due to hydrolysis under alkaline or acid conditions. If hard water that is too alkaline is used to dilute the agricultural chemical, its effectiveness is reduced due to degradation of the active.

The solution to the pH instability problem taught in Fisher, et al., U.S. Pat. No. 5,514,639 is to provide a pH-adjusting agricultural concentrate with an active ingredient made up of acids, alkalis and buffers for controlling and modifying the pH of water, called the “agricultural adjuvant” therein. Fisher, et al., advocate the of an appropriate pH color indicator in the water to contact the pH-sensitive agricultural chemical, to avoid the need by personnel to use pH meters or test strips in preparing for application of the agricultural chemical.

Fisher, et al. emphasize the importance of using the pH-adjusting adjuvant in advance to modify the pH of the water. As noted in that patent, “[a]ny pH modification should preferably take place before the agricultural chemical is added to the mixture. This prevents degradation of the chemical prior to modification of the pH, and avoids any colour masking of the pH indicator in the mixture by the agricultural chemical.”

The pH instability problem affects the effectiveness and lifetime of an active ingredient not only during application of the bioactive ingredient, but also after application. To maximize the effectiveness of an application, the pH after application will preferably remain in a range where the half-life of the active is high. An inert ingredient can address this problem if it can provide a pH buffering effect.

The present invention provides an alternative solution to the pH instability problem, an alternative solution to the solubility and dispersion issues with bioactive ingredients that are not highly water soluble, and an alternative environmentally benign inert ingredient for the preparation of bioactive formulations.

Certain of the several embodiments of the present invention provide benefits and advantages over the bioactive compositions and methods of the art.

One benefit of some contemplated compositions of the present invention is the reduction of the need for use of buffers, surfactants and/or other chemicals that have been used in the art to stabilize active ingredients.

One advantage of some contemplated compositions of the present invention is the reduction of the need for use of buffers, surfactants and/or other chemicals that have been used in the art to enhance dispersability of the active ingredients.

An additional benefit of some contemplated compositions of the present invention is the reduction of the chemical burden on the environment from the inert ingredients of the formulation.

A further advantage of some contemplated compositions of the present invention is that the present invention makes production and use of bioactive formulations more easy and economical.

Still further benefits and advantages of the present invention are appreciated by those in the art.

### BRIEF SUMMARY OF THE INVENTION

The present invention provides a method of stabilizing a bioactive ingredient in a composition by including a C₁ to C₄ alkyl lactate ester in the composition. The bioactive ingredient includes pesticides, herbicides, defoliants, safeners, desiccants, plant nutrients, fungicides, insecticides and preservatives. The stabilizing includes providing a measure of defense against alkaline hydrolysis as well as solubilizing the bioactive ingredient; both of which serve to prolong the shelf-life and efficacy of the bioactive.

The present invention contemplates a formulation that is a concentrate containing an active ingredient (bioactive) dissolved in (a) a C₁-C₄ alkyl ester of lactic acid, preferably ethyl lactate, or (b) a biosolvent mixture of a C₁-C₄ alkyl ester of lactic acid, preferably ethyl lactate, with d-limonene or (c) C₁-C₄ alkyl ester of lactic acid, preferably ethyl lactate, with fatty acid methyl ester. A contemplated concentrate can be readily diluted with a diluent, for example water, as typically occurs during application of the bioactive. Once applied, the diluted formulation will maintain the pH in the vicinity of the applied bioactive at a slightly acidic pH range.

The present invention provides a self-buffering, water miscible inert carrier for an active ingredient that also happens to be approved for use by organic farmers without endangering their “organic” classification. The inert carrier is a C₁-C₄ alkyl ester of lactic acid (an alkyl lactate). The active ingredient is typically a bioactive of some sort, such as a pesticide, defoliant, or desiccant. Thus, pesticides and herbicides are contemplated as active ingredients. The invention also contemplates active ingredients to provide useful compositions such as wood preservatives. In some embodiments of the present invention, it is preferred to further combine a pleasant-smelling ingredient, such as d-limonene. The compositions are particularly useful where the active ingredient is subject to hydrolysis at higher pHs, because the alkyl lactate provides a mildly acidic environment for the active ingredient during storage, which increases the shelf life and stability of the formulation. The alkyl lactate also provides a mildly acidic environment for the active ingredient for quite some time after application of the formulation, typically with aqueous dispersal.

### DETAILED DESCRIPTION OF THE INVENTION

The present invention contemplates methods and materials regarding a formulation that is a concentrate containing an active ingredient (bioactive ingredient) dissolved in (a) a C₁-C₄ alkyl ester of lactic acid, preferably ethyl lactate, or (b) a biosolvent mixture of a C₁-C₄ alkyl ester of lactic acid, preferably ethyl lactate, with d-limonene or (c) C₁-C₄ alkyl ester of lactic acid, preferably ethyl lactate, with fatty acid methyl ester. A contemplated concentrate can be readily diluted with a diluent, for example water, as typically occurs during bioactive application. Once applied, the diluted formulation will maintain the pH in the vicinity of the applied bioactive ingredient at a slightly acidic pH range.

Some benefits of a contemplated composition include (i) reduction of the use of buffers, surfactants and other chemicals used in the art to stabilize active ingredients and enhance dispersability, and (ii) reduction of the chemical burden on the environment from the inert ingredients of the formulation, and (iii) making production and use of bioactive formulations more easy and economical.

The present invention provides a self-buffering, water miscible inert carrier for an active ingredient. The inert carrier is a C₁-C₄ alkyl ester of lactic acid (an alkyl lactate). An active ingredient is present in the inert carrier. The present invention contemplates compositions that are formulations of an active ingredient, preparations of an active ingredient, methods of using a formulation, methods of extending the lifetime of an active ingredient in a formulation, and methods of extending the lifetime of an active ingredient after application.

Compositions and methods of some pesticide and plant nutrient embodiments of the present invention should be of particular interest to organic farmers. The issue of the environmental burden caused by such chemicals that are used as inactive ingredients in the formulations of the art, was raised with many regulatory agencies, environmentalists and crop growers. The United States Department of Agriculture (USDA) passed regulations effective Oct. 21, 2002, that require inert ingredients in pesticides used on organic food to be on the Environmental Protection Agency (EPA) List 4A or B, which identifies inert ingredients of minimal concern. Many pesticide formulations used by organic farmers did not meet those requirements, restricting the ability of the organic farmers to use of many currently available pesticide formulations.

The EPA announced an “Exemption from the Requirement of a Tolerance” for ethyl lactate and butyl lactate in List 4A inert ingredients, knocking down the legal barrier to the use of such C₁-C₄ lactates in pest control products used by organic farmers was removed. A listed 4A inert can be used with exempted active ingredients without jeopardizing the exempted status of the pesticide product. The EPA reserves 4A inert status for ingredients that are common foods or substances that are ubiquitous in nature and are not expected to present a hazard to human health or the environment.

In several preferred embodiments of the present invention, ethyl lactate is the preferred C₁-C₄ alkyl lactic acid ester. Ethyl lactate is a solvent that is readily miscible in water as well as in many hydrophobic solvents. It is derived from renewable carbohydrates via fermentation to lactic acid and ethanol and recovery by reaction and distillation. Thus, the recent regulatory actions provide the use of certain biosolvents, which are readily derived from renewable resources and in combination, provides a wide range of hydrophilicity and hydrophobicity, as inerts for pesticide formulations.

Lactate esters, particularly ethyl lactate, alone or in combination with the other EPA Class 4 approved biosolvents provide some excellent benefits for bioactive formulations. The two primary benefits are mildly acidic pH buffering and reduced need for surfactants in a bioactive formulation, as discussed below. These desirable properties are maintained when bioactive ingredients, such as pesticides, are dissolved in the solvents.

Lactate esters slowly and steadily provide a slightly acidic pH in their local environment once the formulation is diluted in water and applied. The lactate ester slowly hydrolyzes to lactic acid and alcohol, and the released lactic acid provides a slightly acidic pH range of 5 to 6, giving rise to the first benefit. Such mildly acidic conditions enhance the effectiveness and lifetime of bioactive ingredients that are subject to alkaline hydrolysis.

Surfactants are another class of major chemicals used in many formulations of the art. Surfactants are used primarily to provide bridging action between the hydrophobic organic solvent that dissolves the active ingredients. Surfactants are also used to enhance dispersability into large volumes of water during the application of the active ingredient. Many of the surfactants used in products of the art are NOT inert ingredients approved by the USDA for use by organic farmers.

A review of the trade literature and the various manufacturers' Material Safety Data Sheets (MSDS) reveals the use of numerous classes of surfactants. In many formulations these surfactants are in fairly high concentrations often between 5 to 20%. The alkyl lactic acid ester compositions of the invention can optionally contain surfactants, however, in an embodiment where the goal is to reduce the ecological burden, a minimal amount of surfactant is used, preferably less than about 5 percent of the composition, most preferably less than about 1 percent.

The ability of the lactate esters to maintain high solvating properties even when dissolved in the other hydrophobic biosolvents enables the second property. Surfactant requirements are reduced because the active ingredients can be kept in the water miscible biosolvent in a concentrated form without additional hydrophobic solvents. The biosolvent formulation of the active ingredient does not require high concentrations of surfactants to ensure thorough mixture and dispersal of the formulation in the diluting aqueous solution, because it is also water miscible.

The C₁-C₄ alkyl ester of lactic acid includes the saturated alkyls: methyl lactate, ethyl lactate, n-propyl lactate, i-propyl lactate, n-butyl lactate, i-butyl lactate, t-butyl lactate, 1-methylpropyl lactate. The C₁-C₄ alkyl esters of lactic acid are preferred over longer chain alkyl esters for use in the present invention in order to maintain miscibility with water, while enhancing solubility of an active ingredient, where necessary. Although other carboxylic acids besides lactic acid could be used, however, the focus of the present invention is upon lactic acid due the advantage of its ready availability from biological sources.

In most embodiments of the present invention, the preferred C₁-C₄ alkyl ester of lactic acid is ethyl lactate. Ethyl lactate is commercially available from Vertec Biosolvents, Inc. (Downer's Grove, Ill., USA), preferably in the pesticide application as a solvent grade, VertecBio EL™ (solvent grade ethyl lactate). In embodiments of the present invention where a mixture of ethyl lactate with d-limonene is preferred, such a mixture is commercially available from Vertec Biosolvents, Inc. (Downer's Grove, Ill., USA) as VertecBio Citrus™ (ethyl lactate and d-limonene). In embodiments of the present invention where a mixture of ethyl lactate with methyl fatty acid ester is preferred, such a mixture is commercially available from Vertec Biosolvents, Inc. (Downer's Grove, Ill., USA) as VertecBio Gold™ (ethyl lactate and soy methyl esters).

A contemplated active ingredient is typically a bioactive ingredient of some sort. The bioactive ingredients include biocides, pesticides, insecticides, fungicides, herbicides, defoliants, desiccants, preservatives, and nutrients. The list of bioactive ingredients is a combination of genera of varying, and overlapping scopes. Pesticides, as used by some in the art, include herbicides, defoliants, fungicides and insecticides. Depending on the embodiment, the preferred bioactive ingredient varies depending on the embodiment of the present invention. For a pesticide contemplated for organic gardening, certain “organic” pesticides (discussed below) are contemplated. The invention also contemplates active ingredients to provide useful compositions such as wood preservatives.

In some embodiments of the present invention, it is preferred to further combine a miscible, hydrophobic molecule, such as d-limonene or a fatty acid methyl ester as a co-solvent. These compositions are particularly useful where the active ingredients are not appreciably soluble in aqueous solution, thereby raising issues of dispersability in the inert ingredients in a formulation of that bioactive ingredient. In the case of d-limonene, another additional, or alternative benefit is the pleasing odor it imparts to the composition as well as lowers the freezing point of the solvent mixture.

Several biologically derived solvents such as d-limonene and fatty acid methyl ester (e.g. cottonseed oil) are on inerts list 4B, which is a list of ingredients very low concern for toxicity and environmental issues. D-limonene is derived from citrus peels, is readily degradable, and non-toxic. D-limonene acts as a hydrophobic solvent. Fatty acid methyl esters are derived from vegetable oil fatty acids, and are also readily degradable and non-toxic. Such fatty acids also tend to be by hydrophobic, and thus not easily dispersible with water.

In a composition of the present invention. D-limonene and/or fatty acid methyl esters can provide some useful properties—particularly where an active ingredient is not appreciably soluble in water. In some preferred embodiments of the present invention, a composition contains D-limonene and/or a fatty acid methyl ester in addition to the alkyl lactate.

In some embodiments of the present invention, the compositions of the present invention provide particular advantages where the active ingredient is subject to hydrolysis at higher pHs, because the alkyl lactate provides a mildly acidic environment for the active ingredient during storage, which increases the shelf life and stability of the formulation. The alkyl lactate also provides a mildly acidic environment for the active ingredient for quite some time after application of the formulation, typically with aqueous dispersal.

In embodiments of the present invention where a goal is to prepare a pesticide that minimizes adverse ecological impact, preferred pesticides are organic pesticides. Examples of preferred pesticides include azadirachtin (for example from Agro Logistic, Certis USA, PBT International, AMVAC Chemical, PBI Gordon, Agridyne, Vikwood Botanicals or Grace Biopesticides), cinnamaldehyde (for example from A. H. Hoffman, Proguard Inc., Micro-Flo, A. H. Robins, Monterey Chemicals, Seargeants Pet Prod., Mobil Chemical) and dihydroazadirachtin (Certis USA).

Other active ingredients contemplated in various environmentally friendly embodiments for formulation include neem extract and neem cake (e.g. from Agro Logistic Systems Inc., Diamond Bar, Calif.), pyrethrum (e.g. PyGanic Crop Protection EC from MGK Company, Minneapolis, Minn.).

Other bioactive ingredients contemplated for formulation in a composition of the invention include the broad classes of compounds that are pesticides, defoliants, desiccants and plant nutrients; the preceding class including pesticides such as insecticides, nematocides, fungicides and herbicides; the preceding class including organophosphates, carbamates, benzimidazoles, dicarboxamides, bipyridols, pyrethroids and chlorinated hydrocarbons. Typical examples of the preceeding class include azinphos methyl, benomyl, captan, dimethoate, ethyl parathion, methomyl, trichlorfon, oxamyl, dibrom, dimecron, mevinphos, monocrotophos, paraquat, diquat, cypermethrin and dicofol.

Many agricultural chemicals have optimum agricultural activity in a slightly acidic pH range of e.g. pH 4-6. For most of the active ingredients, the optimum pH is in the range of 5.0 to 6.5 (slightly acidic). In Table 1 we have listed some of the common pesticides and their half lives at various pHs. This data illustrates the importance of alkaline hydrolysis, which is a major issue in the formulation and end use of many pesticides. Carbamates and organophosphates are more susceptible to degradation than chlorinated hydrocarbons or pyrethroids. Sevin is carbaryl and Dursban is chlorpyrifos.

Alkaline hydrolysis is a real problem for bioactive ingredients. Many water sources used to dilute and apply bioactives are hard water sources and have considerable alkalinity and some soils as well as plants can be alkaline, many formulations contain buffering chemicals and pH indicating chemicals. For example, U.S. Pat. No. 5,514,639 by Fisher et al teaches the use of pH buffers as well as pH indicators for use with such pH sensitive agrochemicals. These chemicals are used in significant amounts to the formulations, in addition to the active ingredients and solvents that dissolve the active ingredients.

| Pesticide | | | | | | |
|---|---|---|---|---|---|---|
| (trade | Chemical | ½ Life at pH | | | | |
| name) | type | 9.0 | 8.0 | 7.0 | 6.0 | 5.0 |
| Captan | captan | 2 min | 10 min | 3 hr | — | 10 hr |
| Guthion | azin-phos | 12 hr | — | — | — | 60 hr |
| | methyl | | | | | |
| Sevin | carbaryl | 24 hr | — | 10 days | — | — |
| Benlate | benomyl | — | — | 1 hr | — | 30 hr |
| Dursban | chlorpyrofos | — | 1.5 days | 35 days | — | 63 days |
| Cygon | dimethoate | 48 min | — | — | 12 hr | — |
| Malathion | malathion | 5 hr | 19 hr | 3 days | 8 days | — |
| Imidan | phosmet | — | 4 hr | 12 hr | — | 7 days |

In a preservative embodiment of the present invention, a contemplated active ingredient is a preservative used in the wood treatment arts for treating wood for use as lumber against degradation such as from insects, fungus and rot. One example of such a preservative is propiconazole or tebuconazole in combination with benzalkonium chloride, 3-iodo-2-propynyl-n-butyl carbamate, flufenoxuron, permethrin, propiconazole, and/or copper carbonate hydroxide. Such preservatives are commercially available from a wide variety of industrial sources, for amateur, industrial and professional applications. In a contemplated embodiment, the bioactive preservative(s) are present in a C₁ to C₄ alkyl lactic acid ester-based composition.

The invention, and some of the beneficial properties of compositions of the invention are illustrated in the following Examples.

### EXAMPLE 1

### pH Study of Dilute Solutions of VertecBio™ Solvents

This example demonstrates the slow hydrolysis and pH reduction properties of the following biosolvents of the present invention: (a) ethyl lactate (Vertec BioSolvents, Inc., VertecBio Gold™ blend), (b) ethyl lactate in d-limonene (VertecBio Citrus™ blend), and (c) ethyl lactate in fatty acid methyl ester (VertecBio Gold™ blend).

The biosolvents were diluted in water at one, two, and three percent concentrations to demonstrate the effects of hydrolysis on the solvents. The Citrus and Gold blends were made of 80% Ethyl lactate and 20% d-limonene and methyl soyate respectively. The pH was measured at various intervals and was recorded.

The general trend shows the pH declining over time, with the most dramatic changes taking place within the first 24 hours. The initial pH of the water was approximately 7.80 pH units.

| | | | 4 | 6 | 8 | 24 | 48 | 72 |
|---|---|---|---|---|---|---|---|---|
| | Initial | 2 hours | hours | hours | hours | hours | hours | hours |
| 1% Ethyl | 7.75 | 7.25 | 7.10 | 6.95 | 7.11 | 6.78 | 6.75 | 6.56 |
| Lactate | | | | | | | | |
| 2% Ethyl | 7.65 | 7.14 | 7.00 | 6.90 | 6.90 | 6.56 | 6.43 | 5.88 |
| Lactate | | | | | | | | |
| 3% Ethyl | 7.54 | 7.01 | 6.90 | 6.78 | 6.79 | 6.47 | 5.93 | 5.47 |
| Lactate | | | | | | | | |
| 1% Vertec | 7.75 | 7.43 | 7.38 | 7.30 | 7.28 | 6.99 | 6.88 | 6.40 |
| Bio | | | | | | | | |
| Citrus ™ | | | | | | | | |
| 2% Vertec | 7.61 | 7.25 | 7.16 | 7.15 | 7.05 | 6.81 | 6.49 | 5.85 |
| Bio | | | | | | | | |
| Citrus ™ | | | | | | | | |
| 3% Vertec | 7.60 | 7.14 | 7.06 | 7.00 | 6.97 | 6.69 | 6.10 | 5.46 |
| Bio | | | | | | | | |
| Citrus ™ | | | | | | | | |
| 1% Vertec | 7.75 | 7.43 | 7.38 | 7.35 | 7.27 | 7.03 | 7.04 | 6.75 |
| Bio Gold ™ | | | | | | | | |
| 2% Vertec | 7.69 | 7.29 | 7.24 | 7.13 | 7.09 | 6.80 | 6.56 | 6.10 |
| Bio Gold ™ | | | | | | | | |
| 3% Vertec | 7.58 | 7.2 | 7.09 | 7.04 | 6.96 | 6.62 | 6.23 | 5.66 |
| Bio Gold ™ | | | | | | | | |

### EXAMPLE 2

### pH Study of Dilute Solutions of VertecBio™ Solvents with Dichlorvos

In this example, the pH of a dilute solution of an organophosphate pesticide is tracked over time. The dilution into water is done without any surfactants.

The biosolvents were diluted in water at one, two, and three percent concentrations. The solvents, before being diluted, contained 1% dichlorvos. The VertecBio Citrus™ and Gold™ blends were made of 80% ethyl lactate and 20% d-limonene and methyl soyate respectively. The pH was measured and recorded at various intervals to demonstrate the effects of hydrolysis on the samples.

The general trend shows the pH declining over time, with the most dramatic changes taking place within the first 24 hours. The initial pH of the water was approximately 7.80 pH units.

| | | | 24 | 48 | 72 |
|---|---|---|---|---|---|
| | Initial | 4 hours | hours | hours | hours |
| 1% Ethyl | 7.72 | 7.3 | 7.15 | 7.08 | 6.89 |
| Lactate | | | | | |
| 2% Ethyl | 7.5 | 7.14 | 6.92 | 6.55 | 6.04 |
| Lactate | | | | | |
| 3% Ethyl | 7.51 | 6.97 | 6.6 | 6.28 | 5.45 |
| Lactate | | | | | |
| 1% Vertec | 7.63 | 7.26 | 7.07 | 6.73 | 6.62 |
| Bio Citrus | | | | | |
| 2% Vertec | 7.52 | 7.09 | 6.8 | 6.59 | 6.15 |
| Bio Citrus | | | | | |
| 3% Vertec | 7.44 | 7 | 6.79 | 6.17 | 5.47 |
| Bio Citrus | | | | | |
| 1% Vertec | 7.68 | 7.32 | 7.11 | 6.54 | 6.66 |
| Bio Gold | | | | | |
| 2% Vertec | 7.68 | 7.14 | 6.96 | 6.3 | 6.02 |
| Bio Gold | | | | | |
| 3% Vertec | 7.6 | 6.99 | 6.55 | 6.12 | 5.95 |
| Bio Gold | | | | | |

### EXAMPLE 3

### pH Study of Dilute Solutions of VertecBio™ Solvents with Neem Oil Containing the Natural Pesticide Azadirachtin

The biosolvents were mixed with 3% (w/w) neem oil containing the natural pesticide azadirachtin. These were diluted in water at one, two, and three percent concentrations. The Citrus™ and Gold™ blends were made of 80% ethyl lactate and 20% d-limonene and methyl soyate, respectively, as described above. The pH was measured and recorded at various intervals to demonstrate the effects of hydrolysis on the samples. The general trend shows the pH declining over time, with the most dramatic changes taking place within the first 24 hours. The initial pH of the water was 7.80 pH units.

| | | | 24 | 48 | 72 |
|---|---|---|---|---|---|
| | Initial | 4 hours | hours | hours | hours |
| 1% Ethyl | 7.59 | 7.43 | 6.77 | 6.94 | 6.39 |
| Lactate | | | | | |
| 2% Ethyl | 7.41 | 7.25 | 6.75 | 6.74 | 6.02 |
| Lactate | | | | | |
| 3% Ethyl | 7.31 | 7.14 | 6.68 | 6.61 | 5.78 |
| Lactate | | | | | |
| 1% Vertec Bio | 7.56 | 7.33 | 7.03 | 7.05 | 6.53 |
| Citrus ™ #7 | | | | | |
| 2% Vertec Bio | 7.2 | 7.14 | 6.96 | 6.92 | 6.27 |
| Citrus ™ #7 | | | | | |
| 3% Vertec Bio | 7.06 | 6.94 | 6.9 | 6.67 | 5.94 |
| Citrus ™ #7 | | | | | |
| 1% Vertec Bio | 7.4 | 7.39 | 7.34 | 7.15 | 7.03 |
| Gold ™ #7 | | | | | |
| 2% Vertec Bio | 7.36 | 7.23 | 7.14 | 6.89 | 6.45 |
| Gold ™ #7 | | | | | |
| 3% Vertec Bio | 7.22 | 7.12 | 6.87 | 6.6 | 5.91 |
| Gold ™ #7 | | | | | |

From the foregoing, it will be observed that numerous modifications and variations can be effected without departing from the true spirit and scope of the present invention. It is to be understood that no limitation with respect to the specific examples presented is intended or should be inferred. The disclosure is intended to cover by the appended claims modifications as fall within the scope of the claims.

1. A method of stabilizing a bioactive ingredient in a bioactive composition from alkaline hydrolysis by providing a C₁-C₄ alkyl lactic acid ester in a composition with a bioactive ingredient.

2. The method according to claim 1 wherein the bioactive ingredient is a pesticide, insecticide, herbicide, fungicide, desiccant, safener, preservative or plant nutrient.

3. The method according to claim 1 wherein the C₁-C₄ alkyl lactic acid ester is ethyl lactate or butyl lactate.

4. The method according to claim 1 further comprising the step of providing d-limonene or fatty acid methyl ester in the composition with the bioactive ingredient.

5. The method according to claim 1 further comprising the step of providing a co-solvent to aid in solubilizing a hydrophobic bioactive ingredient.

6. The method according to claim 1 wherein the bioactive ingredient is stabilized by buffering with C₁-C₄ alkyl lactic acid ester in the neutral to slightly acidic pH range between 8.0 to 5.0.

7. The method according to claim 1 wherein the bioactive ingredient is stabilized by solubilizing the bioactive ingredient with C₁-C₄ alkyl lactic acid ester.

8. The method according to claim 2 wherein the pesticide is an organic pesticide selected from the group consisting of azadirachtin, cinnamaldehyde, and dihydroazadirachtin.

9. The method according to claim 8 wherein the azadirachtin is provided by using neem oil as the active ingredient.

10. A self buffering bioactive composition that buffers in the neutral to slightly acidic pH range between 8.0 to 5.0, comprising:
(a) a C₁-C₄ alkyl lactic acid ester; and
(b) a bioactive.

11. The self buffering bioactive composition according to claim 10 wherein the bioactive composition is selected from the group consisting of a solution, an emulsion, and a suspoemulsion.

12. The self buffering bioactive composition according to claim 10 further comprising d-limonene or fatty acid methyl ester.

13. The self buffering bioactive composition according to claim 10 wherein the biocide is selected from the group consisting of pesticides, insecticides, defoliants, desiccants, safener, preservative and plant nutrients.

14. The self buffering bioactive composition according to claim 13 wherein the pesticide is an organic pesticide selected from the group consisting of azadirachtin, cinnamaldehyde, and dihydroazadirachtin.

15. The self buffering bioactive composition according to claim 14 wherein the azadirachtin is provided by using neem oil as the active ingredient.
